(19) United States
(12) Patent Application Publication
(10) Pub. No.: US 2025/0073006 A1
(43) Pub. Date: Mar. 6, 2025

(54) OPERATING METHOD OF WATER FLOSSER AND WATER FLOSSER

(71) Applicant: NINGBO SEAGO ELECTRIC CO., LTD., NINGBO CITY (CN)

(72) Inventors: Zhuting Dong, NINGBO CITY (CN); Yanzhong Cai, NINGBO CITY (CN)

(21) Appl. No.: 18/430,724

(22) Filed: Feb. 2, 2024

(30) Foreign Application Priority Data
Sep. 4, 2023 (CN) 202311130495.5

(51) Int. Cl. A61C 17/02

(52) U.S. Cl. CPC A61C 17/0217; A61C 17/0202

(57) ABSTRACT

The present application proposes an operating method of a water flosser and a water flosser. The operating method of the water flosser includes a spot spraying mode and a pause mode; the spot spraying mode and the pause mode are switchable by an operation of a user; in the spot spraying mode, the water flosser does not perform water flossing by default after being powered on, and performing operations by the user enables the water flosser to perform or pause the water flossing; and in the pause mode, the water flosser directly performs the water flossing by default after being powered on, and performing operations by the user enables the water flosser to pause or resume the water flossing.

### TECHNICAL FIELD

The present application belongs to the field of oral cleaning, and specifically pertains to an operating method of a water flosser and a water flosser.

### BACKGROUND

Water flossers are an auxiliary tool for cleaning the oral cavity. It uses pulsed water impact to clean teeth and interdental spaces. Existing water flossers have single operating modes. They either directly perform water flossing after being powered on, which is inconvenient to pause the water flossing; or they do not perform the water flossing by default after being powered on, and the water flossing can be achieved by continuously pressing and holding a water flossing button, which is inconvenient to perform the water flossing.

### SUMMARY

The present application aims to propose an operating method of a water flosser and a water flosser to solve the shortcomings of the water flossers described above.

An example of the present application provides an operating method of a water flosser, the operating method includes a spot spraying mode and a pause mode, and the spot spraying mode and the pause mode are switchable by an operation of a user.

In the spot spraying mode, the water flosser does not perform water flossing by default after being powered on, performing a first operation on a first button by the user enables the water flosser to perform the water flossing, and performing a second operation on the first button by the user enables the water flosser to pause the water flossing.

In the pause mode, the water flosser directly performs the water flossing by default after being powered on, performing a first operation on a second button by the user enables the water flosser to pause the water flossing, and performing a second operation on the second button by the user enables the water flosser to resume the water flossing.

In a possible example, in the spot spraying mode, continuously pressing or toggling the first button by the user enables the water flosser to perform the water flossing, and releasing the pressing or toggling of the first button by the user enables the water flosser to pause the water flossing.

In the pause mode, continuously pressing or toggling the second button by the user enables the water flosser to pause the water flossing, and releasing the pressing or toggling of the second button by the user enables the water flosser to resume the water flossing.

In a possible example, the first button and the second button are the same button.

In a possible example, after the user switches an operating mode of the water flosser, an operating logic of the same button is changed to be different from another operating logic before switching the operating mode.

In a possible example, the spot spraying mode and the pause mode are switchable after or before being powered on.

Another example of the present application provides a water flosser that operates in accordance with the operating method of the water flosser according to any of the technical solutions described above.

In a possible example, the water flosser includes a power button, a mode button and a pause button, the power button is configured to control the water flosser to be powered on and off, the mode button is configured to control the water flosser to switch between the spot spraying mode and the pause mode, the power button and the mode button are arranged at a same circumferential position on an outer circumferential surface of the water flosser, and the first button and the second button are the same pause button.

In a possible example, both the power button and the mode button are located opposite to the pause button on the outer circumference surface of the water flosser.

In a possible example, the pause button is closer to an axial front end of the water flosser than the power button and the mode button.

In a possible example, the pause button is arranged on the outer circumferential surface of the water flosser or on a top of a main body of the water flosser.

By adopting the above-mentioned technical solutions, different operating modes can be selected by switching between the two modes to realize the water flossing and pause the water flossing conveniently.

### BRIEF DESCRIPTION OF THE DRAWINGS

FIG. 1 illustrates a structural schematic view of a water flosser according to an embodiment of the present application.

FIG. 2 illustrates a structural schematic view of a water flosser according to an embodiment of the present application.

FIG. 3 illustrates an internal structural schematic view of a water flosser according to an embodiment of the present application.

### DESCRIPTION OF REFERENCE NUMERALS

1 power button, 2 mode button, 3 pause button, 4 main control board.

### DESCRIPTION OF THE EMBODIMENTS

In order to illustrate the above purposes, features and advantages of the present application more clearly, specific embodiments of the present application are described below in detail with reference to the accompanying drawings. In addition to the embodiments described below, the present application can also be implemented in other ways different from those described here, and those skilled in the art can make corresponding improvements, modifications and substitutions without departing from the spirit of the present application. Therefore, the present application is not limited to the specific embodiments disclosed below. The scope of protection of the present application should be subject to the appended claims.

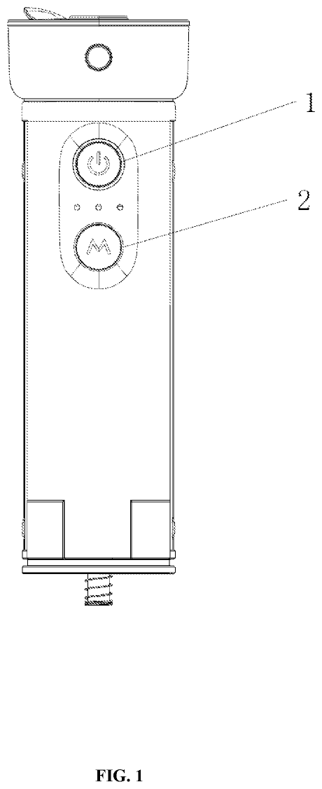

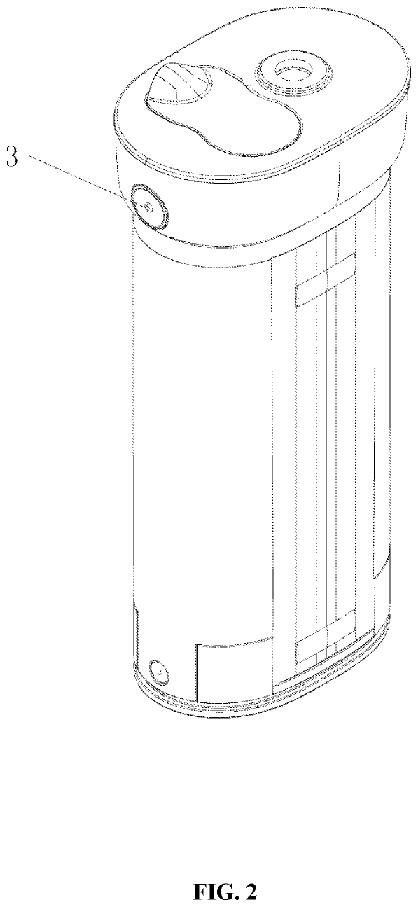

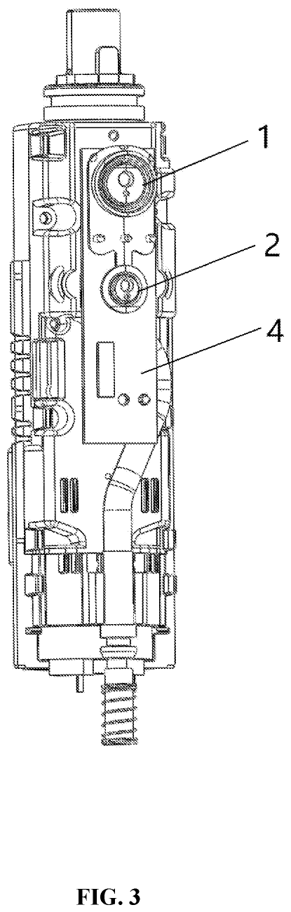

As shown in FIGS. 1 to 3, an embodiment of the present application proposes a water flosser and an operating method of the water flosser. The water flosser is provided with a power button 1, a mode button 2, a pause button 3 and a main control board 4. The main control board 4 may be arranged inside a housing of the water flosser, and the power button 1, the mode button 2 and the pause button 3 are located on a surface of the housing of the water flosser to enable direct operation.

The power button 1 and the mode button 2 may be arranged on the main control board 4, and are electrically connected with the main control board 4. The pause button 3 may be arranged on an upper cover of the water flosser, and the pause button 3 is electrically connected to the main control board 4.

The power button 1, the mode button 2, and the pause button 3 may all be located on an outer circumferential surface of the water flosser. The power button 1 may be located next to the mode button 2, the power button 1 and the mode button 2 may be arranged at a same circumferential position on the outer circumferential surface of the water flosser, the power button 1 and the mode button 2 may be arranged in an axial direction of the water flosser, and the pause button 3 may be arranged opposite to the power button 1 and the mode button 2. The pause button 3 is closer to an axial front end of the water flosser than the power button 1 and the mode button 2, and the axial front end of the water flosser (the upper end in FIGS. 1-3) is a water flossing end, and a handheld end (not shown) when the water flosser is used (the handheld portion is not fully shown in the figures) is an axial rear end of the water flosser (the lower end in FIGS. 1-3).

The power button 1 and the mode button 2 may be positioned to facilitate thumb operation, and the pause button 3 may be positioned to facilitate forefinger operation, making it easy to operate with one hand.

In other possible embodiments, the pause button 3 may also be located on a top of a main body of the water flosser or next to the mode button 2, so that the mode button 2 and the pause button 3 may also be operated with one hand. The power button may not be arranged next to the mode button 2. The power button 1 and the mode button 2 may also be the same button, enabling different functions by long and short presses. The mode button 2 and the pause button 3 may also be the same button, enabling different functions by long and short presses.

The power button 1 may be operated to control power-on and power-off of the water flosser. By operating the mode button 2, an operating mode of the water flosser may be switched, so that the water flosser may switch between a spot spraying mode and a pause mode, and the spot spraying mode and the pause mode may be control methods of the water flosser preset in the main control board 4.

It will be appreciated that the power button 1, the mode button 2 and the pause button 3 may be activated by pressing or toggling.

In the spot spraying mode, the water flosser does not perform water flossing by default after being powered on, performing a first operation on a first button by a user enables the water flosser to perform the water flossing, and performing a second operation on the first button by the user enables the water flosser to pause the water flossing.

In the pause mode, the water flosser directly performs the water flossing by default after being powered on, and performing a first operation on a second button by the user enables the water flosser to pause the water flossing, and performing a second operation on the second button by the user enables the water flosser to resume the water flossing. In this way, the user can select the operating mode of the water flosser according to needs, and may conveniently pause the water flossing or briefly perform the water flossing by short press.

The buttons (the power button 1, the mode button 2 and the pause button 3) may include buttons without a self-locking mechanism and self-locking buttons with a rebound mechanism, and the button without the self-locking mechanism is activated by pressing and is inactivated by release. For the button without the self-locking mechanism, the first operation may be pressing (or toggling) the button and maintain a pressed (or toggled) state, and the second operation may be releasing the pressed (or toggled) button to reset the button.

The self-locking button with the rebound mechanism is activated and self-locked by pressing, and the activated state is maintained even if released, and self-locking is released by pressing again to realize inactivation. For the self-locking button without the rebound mechanism, the first operation may be pressing (or toggling) the button, and the second operation may be pressing the button again after the first operation to release and inactivate the self-locking button or to reset the toggle button.

Further, the first button and the second button may be the same button, that is, both the first button and the second button are the pause buttons 3. After the user switches the operating mode of the water flosser by operating the mode button 2, an operating logic of the pause button 3 is changed to be different from another operating logic before switching the operating mode. Specifically, in the spot spraying mode, the operating logic of the pause button 3 is to press to enable the water flossing and to release to pause the water flossing; and in the pause mode, the operating logic of the pause button 3 is to press to pause the water flossing and to release to enable the water flossing.

In at least one possible embodiment, the mode key 2 may be, for example, a mechanical toggle switch, the mode key 2 may switch the operating mode by physical contacts instead of a program, and the spot spraying mode and the pause mode may be switched after or before being powered on.

In the spot spraying mode, after the water flosser is powered on by operating the power button 1, the water flosser does not perform the water flossing by default, when the pause button 3 is pressed, the water flosser performs the water flossing, and when the pause button 3 is released, the water flosser stops the water flossing. The pause button 3 may be intermittently operated when the water flosser is used to realize the effect of one spraying by one pressing.

Different gear levels may be preset in the spot spraying mode, that is, a water flossing pulse frequency and/or intensity may be preset to different gear levels by pressing the pause button 3 in the spot spraying mode. The gear levels may be shifted by the power button 1 or the mode button 2.

In the spot spraying mode, when the user wants to pause water dispensing, it is only necessary to release the pause button 3, which facilitates operation. The water flosser may be switched to the pause mode by operating the mode button 2 when the user wants continuous water dispensing, in which case it is only necessary to release the pause button 3 to continue the water flossing.

In the pause mode, after the water flosser is powered on by operating the power button 1, the water flosser operates by default at the gear level before being powered off, that is, the water flosser continues water flossing after being powered on. When the pause button 3 is pressed, the water flosser pauses the water dispensing, and the water flosser continues the water flossing after releasing the pause button 3.

In the pause mode, when the user wants the continuous water dispensing, it is only necessary to release the pause button 3, which facilitates operation. The water flosser may be switched to the spot spraying mode or directly powered off by operating the mode button 2 when the user wants to pause the water dispensing continuously.

The operating method of the water flosser of the present application can solve the problems of inconvenient water dispensing in the spot spraying mode and inconvenient pause of the water flossing in the pause mode, and the water flosser can conveniently achieve the water flossing and pause the water flossing.

It should be appreciated that the main control board 4 controls a motor for spraying water to work or not to spray water or not spray water. The switching of the modes and the control of the motor may be implemented by a circuit or software.

What is claimed is:

1. An operating method of a water flosser, comprising a spot spraying mode and a pause mode, wherein the spot spraying mode and the pause mode are switchable by an operation of a user;
in the spot spraying mode, the water flosser does not perform water flossing by default after being powered on, performing a first operation on a first button by the user enables the water flosser to perform the water flossing, and performing a second operation on the first button by the user enables the water flosser to pause the water flossing, and
in the pause mode, the water flosser directly performs the water flossing by default after being powered on, performing a first operation on a second button by the user enables the water flosser to pause the water flossing, and performing a second operation on the second button by the user enables the water flosser to resume the water flossing.

2. The operating method of the water flosser according to claim 1, wherein
in the spot spraying mode, continuously pressing or toggling the first button by the user enables the water flosser to perform the water flossing, and releasing the pressing or toggling of the first button by the user enables the water flosser to pause the water flossing, and
in the pause mode, continuously pressing or toggling the second button by the user enables the water flosser to pause the water flossing, and releasing the pressing or toggling of the second button by the user enables the water flosser to resume the water flossing.

3. The operating method of the water flosser according to claim 1, wherein the first button and the second button are the same button.

4. The operating method of the water flosser according to claim 3, wherein after the user switches an operating mode of the water flosser, an operating logic of the same button is changed to be different from another operating logic before switching the operating mode.

5. The operating method of the water flosser according to claim 1, wherein the spot spraying mode and the pause mode are switchable after or before being powered on.

6. A water flosser operating in accordance with the operating method according to claim 1.

7. The water flosser according to claim 6, wherein the water flosser comprises a power button, a mode button and a pause button, the power button is configured to control the water flosser to be powered on and off, the mode button is configured to control the water flosser to switch between the spot spraying mode and the pause mode, and the power button and the mode button are arranged at a same circumferential position on an outer circumferential surface of the water flosser, and the first button and the second button are the same pause button.

8. The water flosser according to claim 7, wherein both the power button and the mode button are located opposite to the pause button on the outer circumference surface of the water flosser.

9. The water flosser according to claim 7, wherein the pause button is closer to an axial front end of the water flosser than the power button and the mode button.

10. The water flosser according to claim 7, wherein the pause button is arranged on the outer circumferential surface of the water flosser or on a top of a main body of the water flosser.
